(19) United States
(12) Patent Application Publication
(10) Pub. No.: US 2020/0146256 A1
(43) Pub. Date: May 14, 2020

(54) PET GEAR ASSEMBLY

(71) Applicant: LI-CHEN CHEN, Tainan City (TW)

(72) Inventor: LI-CHEN CHEN, Tainan City (TW)

(21) Appl. No.: 16/183,752

(22) Filed: Nov. 8, 2018

(51) Int. Cl. A01K 1/03; F16B 5/00; F16B 5/12

(52) U.S. Cl. CPC A01K 1/033; A01K 15/024; F16B 5/12; F16B 5/0012

(57) ABSTRACT

A pet gear assembly includes at least two main boards, a plurality of supporting posts, and a plurality of side boards. A plurality of through holes are formed in each of the at least two main boards. The plurality of supporting posts are disposed between and perpendicular to the at least two main boards, and two ends of each of the supporting posts respectively pass through each of the through holes. The plurality of side boards are respectively disposed in a frame-shaped area defined by two adjacent ones of the supporting posts and two of the main boards. The at least two main boards, the plurality of supporting posts, and the plurality of side boards jointly form a box unit, and at least one opening is formed in one of the side boards to allow a pet to enter or exit.

### FIELD OF THE DISCLOSURE

The present disclosure relates to a pet gear being assembled with posts and boards, and more particularly to a pet gear assembly that is made of a paper material and that can function as a pet house, a pet toy, and other pet gear.

### BACKGROUND OF THE DISCLOSURE

With the recent rise of environmental awareness, many products that were previously manufactured with plastic materials are now manufactured with recycled paper. Currently, pet gear such as cat houses, cat perches, and dog houses are also transitioning toward being made with cardboard. Pet gear made with cardboard can not only reduce the waste of natural resources, but with paper having the characteristics of being low cost, simply structured, and easily assembled, such pet gear can also have the features of being low cost and allowing for DIY assembly by pet owners.

Conventional paper-made pet gears are generally assembled with cardboard boards. However, the limited material strength of cardboards can cause the assembled pet gears to have weak structural integrity, so that the assembled pet gears is easily damaged and has a short lifespan. Furthermore, the conventional paper-made pet gears are often assembled using tenon joints so that the cardboards can fittingly engage with each other to form a box structure. However, cardboard tenons are not only relatively fragile and easily damaged, but are also difficult to assemble with.

In addition, the box structure adopted by the conventional paper-made pet gear is assembled by folding a flat piece of cardboard. However, in order to be folded into a box, the shape of the flat piece of cardboard would be quite complex, leading to high die-cutting costs and leaving scraps of unused material that unnecessarily raise overall costs.

### SUMMARY OF THE DISCLOSURE

In response to the above-referenced technical inadequacies, the present disclosure provides a pet gear assembly that addresses the issues in the conventional paper-made pet gear assembly having weak structural integrity and being difficult to assemble and easily damaged.

In one aspect, the present disclosure provides a pet gear assembly including at least two main boards, a plurality of supporting posts, and a plurality of side boards. The main boards are spaced apart from each other by a distance and are parallel to each other. A plurality of through holes are formed in each of the at least two main boards, and the positions of each of the through holes on one of the main boards respectively align with the positions of each of the through holes on another one of the main boards. The plurality of supporting posts are disposed between and perpendicular to the at least two main boards, and two ends of each of the supporting posts respectively pass through each of the through holes. The plurality of side boards are respectively disposed in a frame-shaped area defined by two adjacent ones of the supporting posts and two of the main boards, a top side and a bottom side of each of the side boards are respectively connected to the two main side boards, and a left side and a right side of each of the side boards are connected to the two adjacent ones of the supporting posts. The at least two main boards, the plurality of supporting posts, and the plurality of side boards jointly form a box unit, and at least one opening is formed in one of the side boards to allow a pet to enter or exit.

In certain embodiments, the at least two main boards and the plurality of side boards are made of corrugated paper, and the plurality of supporting posts are cylinder structures made of paper. More specifically, the plurality of supporting posts are hollow tube structures, and two sleeve elements are respectively inserted into two ends of each of the supporting posts. The two sleeve elements each have two opposite sleeve portions respectively arranged at two opposite ends of each of the sleeve elements, and the outer diameter of the two sleeve portions complement the inner diameter of the supporting post so that the two sleeve portions can be respectively inserted into the two ends of the supporting post.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 is an assembled perspective view of a pet gear assembly according to one embodiment of the present disclosure;

FIG. 2 is an exploded perspective view of the pet gear assembly according to one embodiment of the present disclosure;

FIG. 3 is a partially exploded perspective view of a box unit of the pet gear assembly according to one embodiment of the present disclosure;

FIG. 4 is an assembled perspective view of the pet gear assembly according to another embodiment of the present disclosure;

FIG. 5 is an exploded perspective view of another configuration of supporting posts of the pet gear assembly according to one embodiment of the present disclosure;

FIG. 6 is an exploded perspective view of the supporting posts of FIG. 5 forming a multi-layered box unit according to one embodiment of the present disclosure; and

FIG. 7 is an assembled perspective view of the embodiment of FIG. 6.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

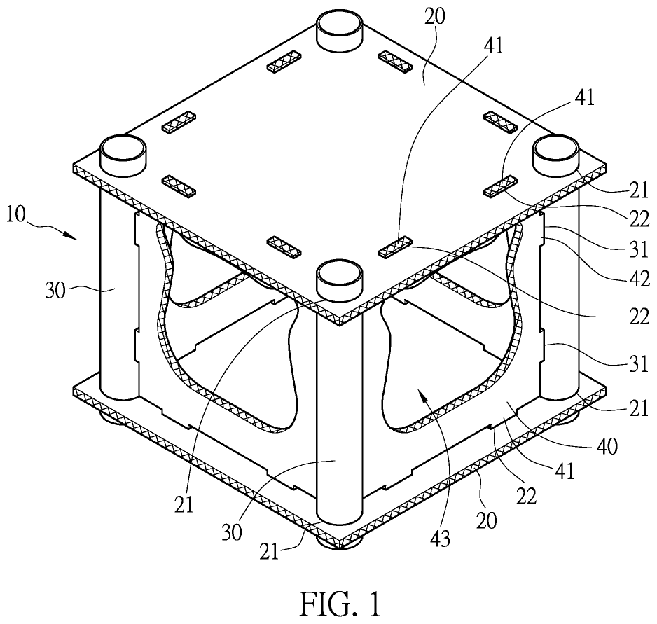

Reference is made to FIG. 1 to FIG. 7, which illustrate the embodiments of a pet gear assembly according to the present disclosure. It should be noted that quantities and shapes mentioned in the present disclosure according to the corresponding figures are referred to for the purpose of describing the invention in detail to facilitate better understanding thereof, and should not be construed as limiting the scope of the present disclosure.

The present disclosure discloses a pet gear assembly that is assembled with paper boards and paper posts. Referring to FIG. 1 to FIG. 3, in order to form a box unit 10 of the pet gear assembly, the box unit 10 further includes at least two main boards 20, a plurality of supporting posts 30, and a plurality of side boards 40. The main boards 20 and the side boards 40 are made of corrugated paper, and the supporting posts 30 can be rolled into form with a paper material, so that the pet gear assembly of the present disclosure can be made of recyclable material and reduce the waste of natural resources.

The two main boards 20 can be boards with a rectangular shape or other geometrical shapes, and are spaced part from each other by a distance and parallel to each other. A plurality of through holes 21 are formed in the two main boards 20 and are respectively formed near the peripheral edges of the two main boards 20, and the positions of each of the through holes on one of the main boards respectively correspond with the positions of each of the through holes on another one of the main boards.

The plurality of supporting posts 30 are disposed between the two main boards 20, and two ends of each of the supporting posts 30 respectively pass through two corresponding ones of the through holes 21 on each of the main boards 20. In this embodiment, the through holes 21 are round holes, and the supporting posts 30 are cylindrical posts to allow the supporting posts 30 to be sleeved through the through holes 21. In order to stabilize the sleeved connection between the supporting posts 30 and the through holes 21, the outer diameter of the supporting posts 30 are designed to be slightly larger than or equal to the inner diameter of the through holes 21, so that the supporting posts 30 and the through holes 21 can be sleevingly connected in a stable manner by virtue of frictional interference therebetween, and the supporting posts 30 are not easily detached from the through holes 21. Aside from the frictional interference, other methods of stably fixing the supporting posts 30 to the through holes 21 can also be implemented, such as applying an adhesive to the conjoining areas between the supporting posts 30 and the through holes 21, or disposing engaging structures such as a flange or a bump at the conjoining areas for engagement therebetween.

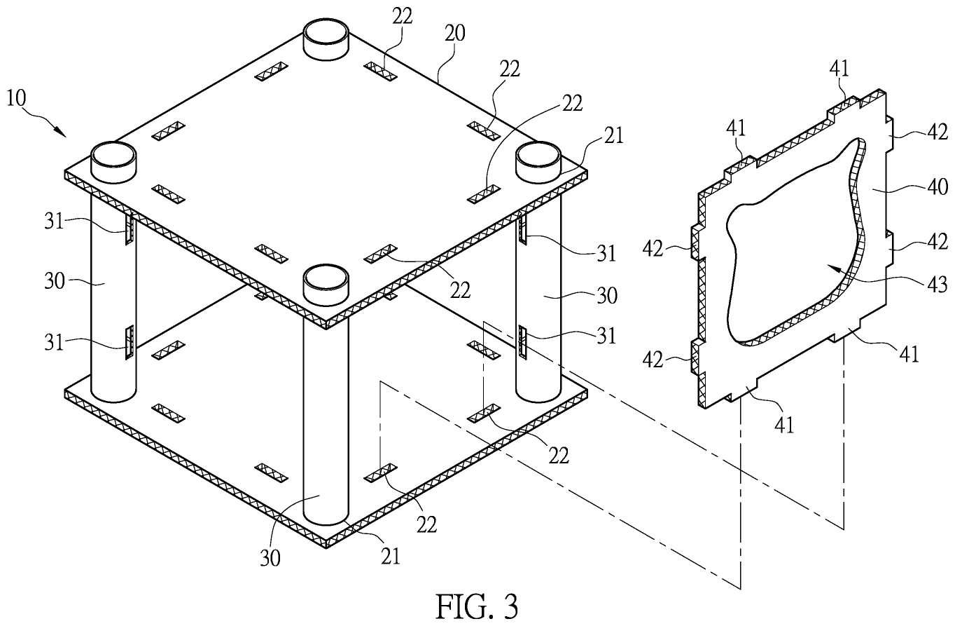

Referring to FIG. 3, after the supporting posts 30 and the main boards 20 are assembled, each two adjacent ones of the supporting posts 30 and the two main boards 20 surroundingly co-define a rectangular frame-shaped area, and the frame-shaped area surroundingly defined by each two adjacent ones of the supporting posts 30 and the two main boards 20 can accommodate one of the side boards 40 therein. When each of the side boards 40 are assembled in the frame-shaped area co-defined by the supporting posts 30 and the two main boards 20, a top side and a bottom side of each of the side boards 40 are respectively connected to the two main boards 20, and a left side and a right side of each of the side boards 40 are respectively connected to the two adjacent supporting posts 30.

In addition, a plurality of first engaging flanges 41 are respectively disposed at the top and bottom sides of the side boards 40, and a plurality of second engaging flanges 42 are respectively disposed at the left and right sides of the side boards 40. In this embodiment, the first and second engaging flanges 41, 42 are respectively formed as a protrusion, and respectively protrude from the top and bottom sides of the side boards 40, and the left and right sides of the side boards 40. Furthermore, in this embodiment, the shapes of the first and second engaging flanges 41, 42 are identical to each other, but in other embodiments of the present disclosure, the first and second engaging flanges 41, 42 can have different shapes.

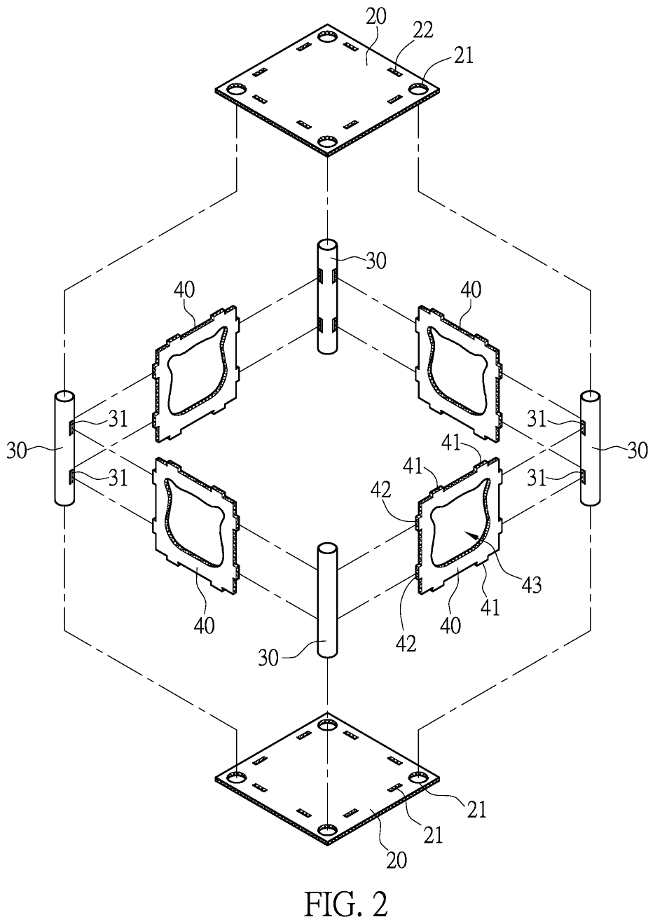

Referring to FIG. 2 and FIG. 3, a plurality of first slots 22 are respectively formed in the two main boards 20 at positions corresponding with the first engaging flanges 41 of each of the side boards 40, and a plurality of second slots 31 are respectively formed in the outer side surfaces of the supporting posts 30 at positions corresponding with the second engaging flanges 42. When the side boards 40 are disposed in the frame-shaped area surroundingly defined by the supporting posts 30 and the two main boards 20, the first engaging flanges 41 at the top and bottom sides of the side boards 40 can engagingly insert into the first slots 22, respectively, and the second engaging flanges 42 at the left and right sides of the side boards 40 can engagingly insert into the second slots 31 at the outer side surfaces of the supporting posts 30, respectively. The sizes of the first slots 22 and the second slots 31 are designed to be tightly engaged with the first engaging flanges 41 and the second engaging flanges 42, so that the first and second engaging flanges 41, 42 can be stably engaged with the first and second slots 22, 31 by frictional interference.

As shown in FIG. 1, when the assembly of the main boards 20, the supporting posts 30, and the side boards 40 is complete, the box unit 10 can be formed. An opening 43 can be formed in the plurality of side boards 40 and can be designed to be in the shape of a circle, a square, a polygon, or other geometrical shapes, or can be designed to be in the shape of an animal to provide visual appeal and attract the attention of a pet. Furthermore, the size of the opening 43 is designed to allow a pet to pass through, so that the pet can enter or exit the box unit 10.

Various types of pet equipment can be placed in the box unit 10 to form a different kind of pet gear. For example, when a cushion is placed in the box unit 10, a pet gear for resting can be formed; when a scratching board for cats is placed in the box unit 10, a pet house for playing or perching can be formed, or when a litter box for cats is placed in the box unit 10, a pet potty house can be formed.

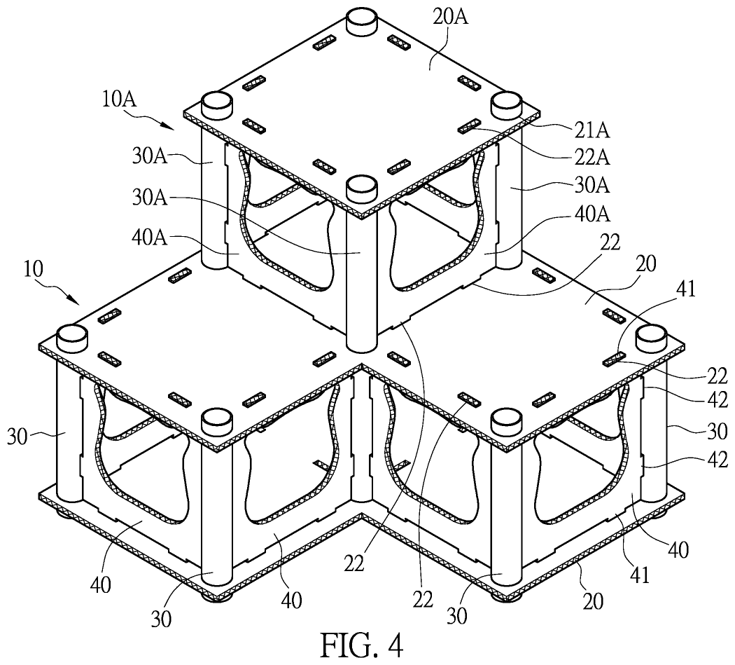

Referring to FIG. 4, another embodiment of the pet gear assembly is shown. In this embodiment, the pet gear assembly is formed by the box unit 10, and another box unit 10A being stacked on top of the main box unit 10. The main one of the box unit 10 includes two main boards 20 respectively formed with a number of rectangular boards to be in an L-shaped geometrical shape. The plurality of through holes 21 are respectively formed in the two main boards 20 near the peripheral edges of the two main boards 20, and the plurality of supporting posts 30 respectively pass through the plurality of through holes 21. The lengths of some of the supporting posts 30A are longer than those of the rest of the supporting posts 30, so that the supporting posts 30A with longer lengths protrude from an outer side of one of the main boards 20 of the box unit 10, and extend toward a direction away from the one of the main boards 20. Furthermore, an end of the supporting posts 30A protruding from the main board 20 is connected with another main board 20A, which co-defines a plurality of the frame-shaped areas with the supporting posts 20A and the main board 20. Furthermore, a side board 40A is disposed in each of the frame-shaped areas so that the another box unit 10A stacked on top of the box unit 10 can be formed by the supporting posts 30A, the main board 20A, and the side boards 40A.

Referring to FIG. 4, the appearance of the box unit 10 can be changed by changing the shape of the main board 20, and another one of the box unit 10 can be connected to the original box unit 10 so that a plurality of box units 10 can be stacked and assembled together to form a multi-layered structure.

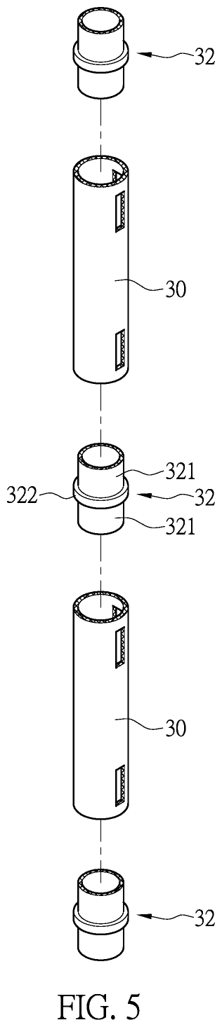

Referring to FIG. 5, in another configuration of the supporting posts 30, each of the supporting posts 30 in this embodiment can be hollow tubes, and two sleeve elements 32 can be respectively inserted into two ends of each of the supporting posts 30. The two sleeve elements 32 each have two opposite sleeve portions 321 respectively arranged at two opposite ends of each of the sleeve elements 32, and a flange portion 322 located between the two sleeve portions 321. The two sleeve portions 321 of the sleeve element 32 are cylindrical in shape, and the outer diameter of the two sleeve portions complements the inner diameter of the supporting posts, so that the two sleeve portions can be respectively inserted into the two ends of the supporting post, and can be stably sleeved in each of the supporting posts by frictional interference.

In this embodiment, the outer diameter of the flange portion 322 of the sleeve element 32 is equal to the outer diameter of the supporting post 30, so that when the sleeve element 32 and the supporting post 30 are sleeved together, the outer side surface of the flange portion 322 of the sleeve element 32 can be flush with the outer side surface of the supporting post 30. Therefore, an integral appearance with a single diameter can be presented when two of the supporting posts 30 are joined together, so that the plurality of supporting posts 30 can be joined together through the sleeve elements 32 to lengthen the supporting posts 30.

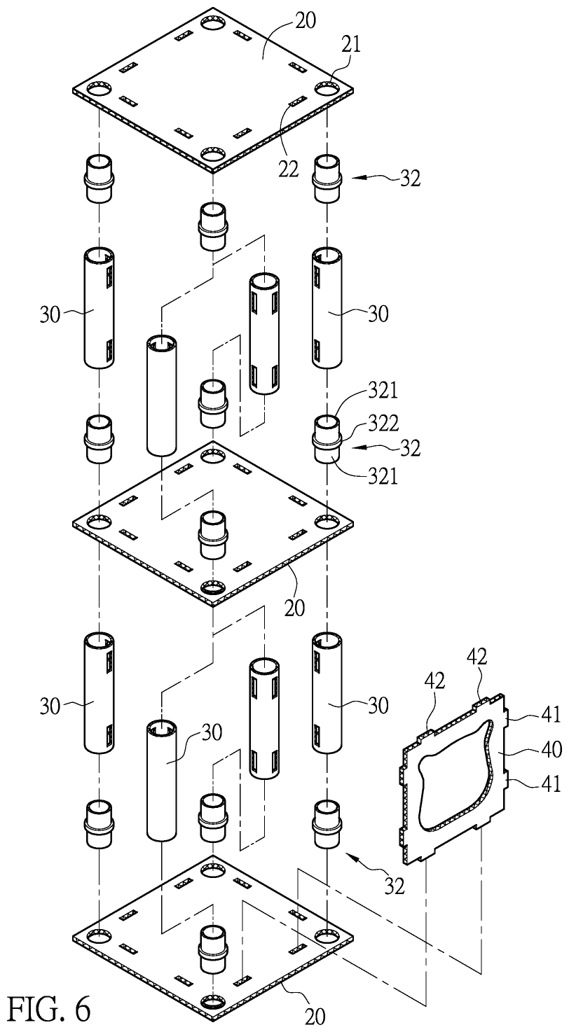

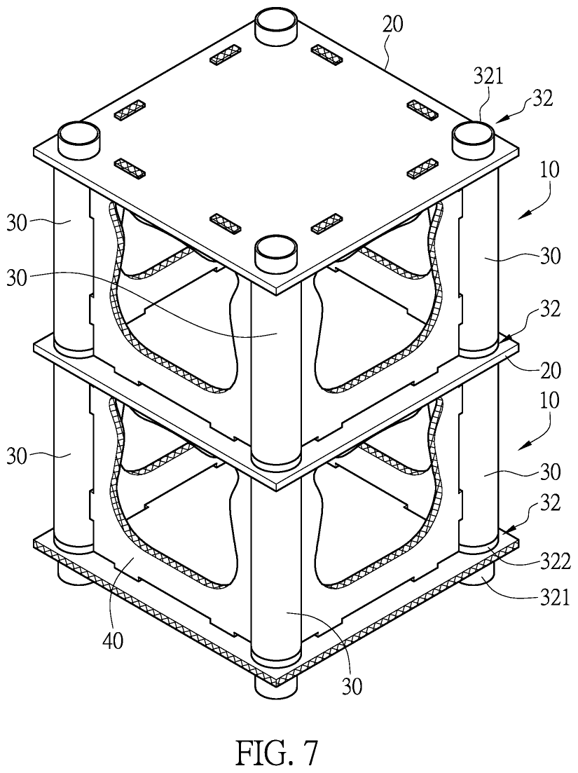

Referring to the embodiment of FIG. 6 and FIG. 7, the plurality of supporting posts 30, the sleeve elements 32, and the plurality of main boards 20 and side boards 40 jointly form a multi-layered box unit. In this embodiment, a sleeve element 32 is respectively sleeved into each of two ends of each of the supporting posts 30. The sleeve portion 321 at one end of the sleeve element 32 is sleeved in an end of one of the supporting posts 30, while the sleeve portion 321 at the other end of the sleeve element 32 is sleeved in one of the through holes 21 of the main board 20. In this embodiment, the diameter of the through hole 21 of the main board 20 complements the diameter of the sleeve portion 321, and the diameter of the through hole 21 is smaller than the diameter of the flange portion 322, so that when the sleeve portion 321 is inserted into the through hole 21, the flange portion 322 can be engaged at the edge of the through hole 21.

In this embodiment, after the sleeve portion 321 of the sleeve element 32 passes through the through hole 21 of the main board 20, the sleeve portion 321 is sleeved into another one of the supporting posts 30. This supporting post 30 can further have an end sleeved around another one of the sleeve elements 32 that in turn connects with the through hole 21 of another one of the main boards 20. Therefore, the main boards 20 and the supporting posts 30 of the present embodiment can be joined together via the sleeve elements 32 and form a stacked structure with multiple box units 10.

In sum, the pet gear assembly of the present disclosure has a stronger structural integrity than the conventional paper-made pet gear assembly, is not easily damaged, and can have a prolonged lifespan. Furthermore, the pet gear assembly of the present disclosure has a simple structure, can be easily assembled, and can allow pet owners to assemble the pet gear assembly themselves so as to increase the convenience of use thereof.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pet gear assembly, comprising:
at least two main boards that are spaced apart from each other by a distance and that are parallel to each other, wherein a plurality of through holes are formed in each of the at least two main boards, and the positions of each of the through holes on one of the main boards respectively correspond with the positions of each of the through holes on another one of the main boards;
a plurality of supporting posts that are disposed between and perpendicular to the at least two main boards, wherein two ends of each of the supporting posts respectively pass through each of the through holes; and
a plurality of side boards that are respectively disposed in frame-shaped areas defined by any two adjacent ones of the supporting posts and the at least two main boards, wherein a top side and a bottom side of each of the side boards are respectively connected to the two main boards, and a left side and a right side of each of the side boards are connected to the two adjacent ones of the supporting posts;
wherein the at least two main boards, the plurality of supporting posts, and the plurality of side boards jointly form a box unit, and at least one opening is formed in one of the side boards to allow a pet to enter or exit.

2. The pet gear assembly according to claim 1, wherein the at least two main boards and the plurality of side boards are made of corrugated paper, and the plurality of supporting posts are cylinder structures made of paper.

3. The pet gear assembly according to claim 2, wherein a plurality of first engaging flanges are disposed respectively at the top side and the bottom side of each of the side boards, a plurality of first slots are respectively formed in the at least two main boards at positions corresponding to the first engaging flanges to provide for insertion of the first engaging flanges, and when the side boards are accommodated in the frame-shaped area, the first engaging flanges are respectively inserted in the first slots.

4. The pet gear assembly according to claim 3, wherein a plurality of second engaging flanges are respectively disposed on the left side and the right side of the plurality of side boards, a plurality of second slots are respectively formed in the plurality of supporting posts at positions corresponding to the second engaging flanges to provide for insertion of the second engaging flanges, and when the side boards are accommodated in the frame-shaped area, the second engaging flanges are respectively inserted in the second slots.

5. The pet gear assembly according to claim 4, wherein some of the plurality of supporting posts protrude from an outer side of one of the main boards and extend toward a direction away from the main board, and an end of the supporting posts that are distant from the main board are connected with another one of the main boards.

6. The pet gear assembly according to claim 5, wherein the plurality of supporting posts are hollow tube structures, and two sleeve elements are respectively inserted into two ends of each of the supporting posts, the two sleeve elements each having two opposite sleeve portions respectively arranged at two opposite ends of each of the sleeve elements, the outer diameter of the two sleeve portions complementing the inner diameter of the supporting post so that the two sleeve portions can be respectively inserted into the two ends of the supporting post.

7. The pet gear assembly according to claim 6, wherein an end of each of the supporting posts is sleeved around one of the sleeve elements, and each of the supporting posts can be connected to another one of the supporting posts through the sleeve elements.

8. The pet gear assembly according to claim 6, wherein the sleeve element is sleeved at an end of the supporting post, the sleeve portion at one end of the sleeve element being sleeved in the end of the supporting post, and the sleeve portion at the other end of the sleeve element being sleeved in one of the through holes in the main board.

9. The pet gear assembly according to claim 8, wherein the sleeve element has a flange portion disposed between the two sleeve portions, the diameter of the through hole of the main board complements the diameter of the sleeve portion, and the diameter of the through hole is smaller than the diameter of the flange portion so that when the sleeve portion is inserted into the through hole, the flange portion can be engaged at the edge of the through hole.

10. The pet gear assembly according to claim 1, wherein the plurality of supporting posts are hollow tube structures, two sleeve elements are respectively inserted into two ends of each of the supporting posts, the two sleeve elements each having two opposite sleeve portions respectively arranged at two opposite ends of each of the sleeve elements, the outer diameter of the two sleeve portions complementing the inner diameter of each of the supporting posts so that the two sleeve portions can be respectively inserted into the two ends of each of the supporting posts.

11. The pet gear assembly according to claim 10, wherein an end of each of the supporting posts is sleeved around one of the sleeve elements, and each of the supporting posts can be connected to another one of the supporting posts through the sleeve elements.

12. The pet gear assembly according to claim 10, wherein the sleeve element is sleeved at an end of the supporting post, the sleeve portion at one end of the sleeve element being sleeved in the end of the supporting post, and the sleeve portion at the other end of the sleeve element being sleeved in one of the through holes in the main board.

13. The pet gear assembly according to claim 11, wherein the sleeve element has a flange portion disposed between the two sleeve portions, the diameter of the through hole of the main board complements the diameter of the sleeve portion, and the diameter of the through hole is smaller than the diameter of the flange portion so that when the sleeve portion is inserted into the through hole, the flange portion can be engaged at the edge of the through hole.
